(19) United States
(12) Patent Application Publication
(10) Pub. No.: US 2023/0169552 A1
(43) Pub. Date: Jun. 1, 2023

(54) Reseller Detection

(71) Applicant: Dell Products L.P., Round Rock, TX (US)

(72) Inventors: Tanuj Arcot Omkar, Cedar Park, TX (US); Rodrigo de Souza Scorsatto, Porto Alegre (BR); Rodrigo da Rosa Righi, Sao Leopoldo (BR); Lucas Micol Policarpo, Santana do Livramento (BR); Vinicius Facco Rodrigues, Sao Jeronimo (BR); Diorgenes Eugenio da Silveira, Sao Leopoldo (BR); Jorge Luis Victória Barbosa, So Leopoldo (BR); Rodolfo Stoffel Antunes, Dois Irmaos (BR); Cristiano André da Costa, Porto Alegre (BR)

(73) Assignee: Dell Products L.P., Round Rock, TX (US)

(21) Appl. No.: 17/537,868

(22) Filed: Nov. 30, 2021

(51) Int. Cl. G06Q 30/06; G06N 3/08

(52) U.S. Cl. CPC G06Q 30/0601; G06N 3/08

(57) ABSTRACT

A method, comprising: obtaining an activity signature for a first user of a retail website, the activity signature being based on one or more of navigation data for the first user of the retail website, purchase data for the first user of the retail website, and credit card usage data for the first user of the retail website; detecting whether the first user of the retail website is a reseller by classifying the activity signature for the first user with a neural network; and updating a configuration of a hosting system of the retail website when the first user of the retail website is detected to be a reseller.

### BACKGROUND

When a popular product is released, it is customary to observe a shortage of the product. This happens when the seller has an insufficient stock of the product to meet demand. Under such circumstances, it is common to see few malicious customers buying as much as possible of the product to resell it later, for a higher price, on various third-party websites. The traditional approach to addressing this problem is to impose a universal limit on purchases of the product that any single customer can make.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

According to aspects of the disclosure, a method is provided, comprising: obtaining an activity signature for a first user of a retail website, the activity signature being based on one or more of navigation data for the first user of the retail website, purchase data for the first user of the retail website, and credit card usage data for the first user of the retail website; detecting whether the first user of the retail website is a reseller by classifying the activity signature for the first user with a neural network; and updating a configuration of a hosting system of the retail website when the first user of the retail website is detected to be a reseller.

According to aspects of the disclosure, a system is provided, comprising: a memory; and one or more processors operatively coupled to the memory, the one or more processors being configured to perform the operations of: obtaining an activity signature for a first user of a retail website, the activity signature being based on one or more of navigation data for the first user of the retail website, purchase data for the first user of the retail website, and credit card usage data for the first user of the retail website; detecting whether the first user of the retail website is a reseller by classifying the activity signature for the first user with a neural network; and updating a configuration of a hosting system of the retail website when the first user of the retail website is detected to be a reseller.

According to aspects of the disclosure, a non-transitory computer-readable medium is provided that stores one or more processor-executable instructions, which, when executed by at least one processor, cause the at least one processor to perform the operations of: obtaining an activity signature for a first user of a retail website, the activity signature being based on one or more of navigation data for the first user of the retail website, purchase data for the first user of the retail website, and credit card usage data for the first user of the retail website; detecting whether the first user of the retail website is a reseller by classifying the activity signature for the first user with a neural network; and updating a configuration of a hosting system of the retail website when the first user of the retail website is detected to be a reseller.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1A is a diagram of an example of a system, according to aspects of the disclosure;

FIG. 1B is a diagram of an example of a reseller detection system, according to aspects of the disclosure;

FIG. 2 is a diagram of an example of a neural network, according to aspects of the disclosure;

FIG. 3 is a diagram of an example of a reseller prevention module, according to aspects of the disclosure;

FIG. 4 is a flowchart of an example of a process, according to aspects of the disclosure;

FIG. 5 is a flowchart of an example of a process, according to aspects of the disclosure;

FIG. 6 is a flowchart of an example of a process, according to aspects of the disclosure;

FIG. 7 is a flowchart of an example of a process, according to aspects of the disclosure; and

FIG. 8 is a diagram of an example of a training data set, according to aspects of the disclosure;

FIG. 9 is diagram of an example of a computing device, according to aspects of the disclosure; and

FIG. 10 is a diagram of an example of an activity signature, according to aspects of the disclosure.

### DETAILED DESCRIPTION

According to aspects of the disclosure, a method and system is provided that identifies customers of a retail website who are likely to be resellers. The method and system allow retail website providers to detect reseller activity on their websites and block it, if desired. Unlike traditional solutions for limiting reseller activity, the method and system do not rely on universal (or hard) limits on the amount of purchases, which a single customer can make. The method and system are advantageous over traditional solutions for limiting reseller activity because they are less likely to constrain large purchases of a product by customers who are not resellers.

The term “reseller” as used herein refers to a customer who is purchasing a product with the intent to re-sell it. Reseller activity may deplete the stock of a product that is available to regular customers (i.e., customers who are not resellers), and decrease customer satisfaction. Blocking or otherwise flagging reseller activity on a retail website may increase customer satisfaction with the retail website by increasing the availability of products that are available to regular customers.

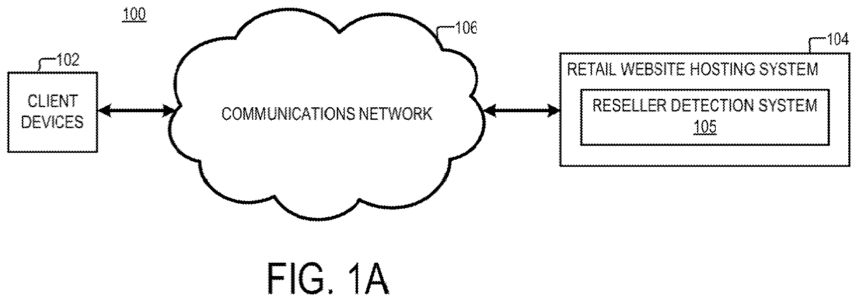

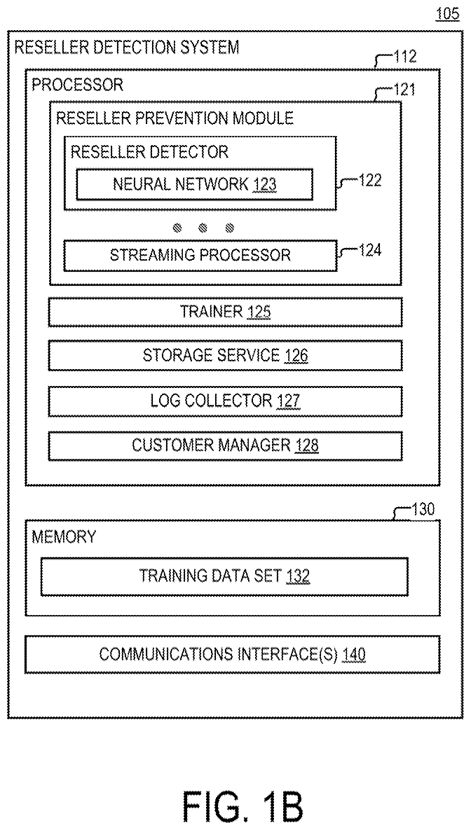

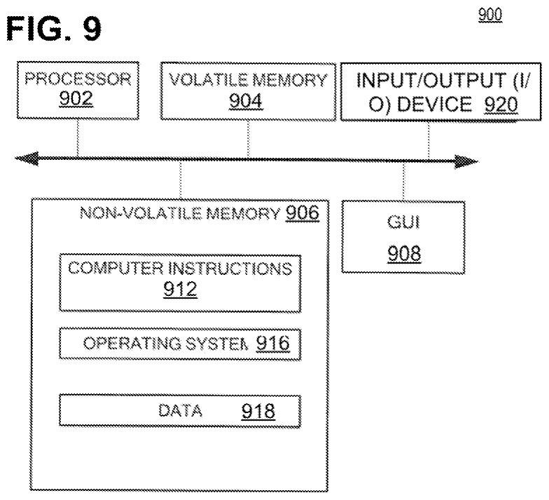

FIG. 1A is a diagram of an example of a system 100, according to aspects of the disclosure. As illustrated, the system 100 may include one or more client devices 102 that are coupled to a hosting system 104 via a communications network 106. Each of the client devices 102 may include a smartphone, a desktop computer, a laptop, and/or any other suitable type of computing device. In some implementations, each of the client devices 102 may be a computing device, such as the computing device 900, which is discussed further below with respect to FIG. 9. The hosting system 104 may include one or more computing devices that are configured to host and/or manage a retail website. The hosting system 104 may include load balancers, frontend servers, backend servers, authentication servers, and/or any other suitable type of computing device. The hosting system 104 may include one or more computing devices, such as the computing device 900, which is discussed further below with respect to FIG. 9. The hosting system 104 may include a reseller detection system 105, as shown. The reseller detection system 105 is discussed further below with respect to FIG. 1B. The communications network 106 may include one or more a local area network (LAN), a wide area network (WAN), the Internet, a 5G cellular network, and/or any other suitable type of communications network.

FIG. 1B is a diagram of the reseller detection system 105, according to aspects of the disclosure. The reseller detection system may include a processor 112, a memory 130, and a communications interface 140. The processor 112 may include any of one or more general-purpose processors (e.g., x86 processors, RISC processors, ARM-based processors, etc.), one or more Field Programmable Gate Arrays (FPGAs), one or more application-specific circuits (ASICs), and/or any other suitable type of processing circuitry. The memory 130 may include any suitable type of volatile and/or non-volatile memory. In some implementations, the memory 130 may include one or more of a random-access memory (RAM), a dynamic random memory (DRAM), a flash memory, a hard drive (HD), a solid-state drive (SSD), a network accessible storage (NAS), and or any other suitable type of memory device. The communications interface 140 may include any suitable type of communications interface, such as one or more Ethernet adapters, one or more Wi-Fi adapters (e.g., 802.1414 adapters), and one or more Long-Term Evolution (LTE) adapters, for example.

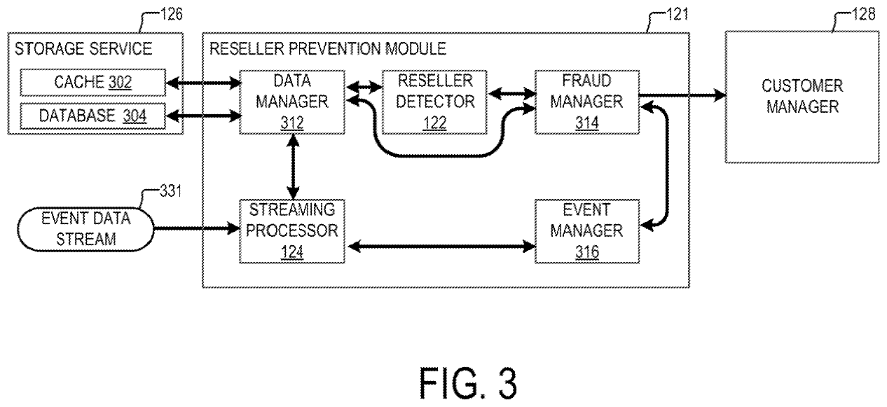

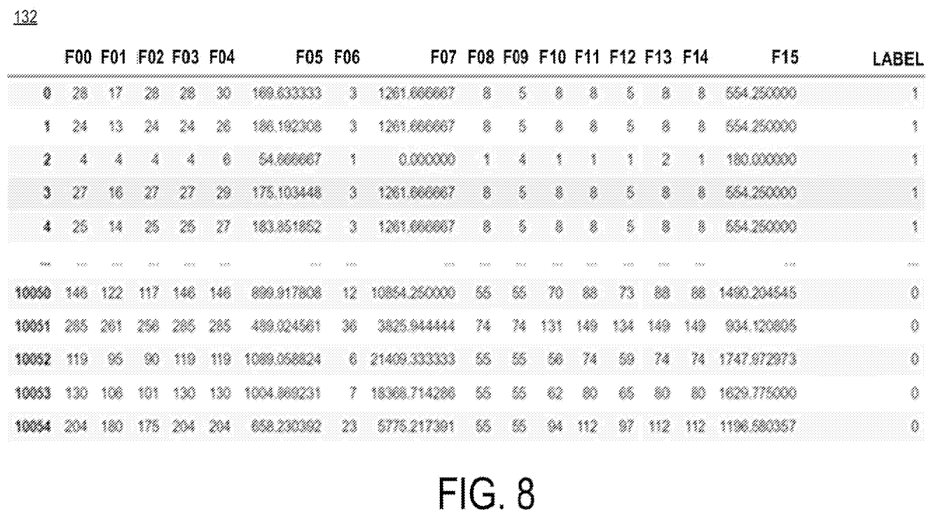

The processor 112 may be configured to execute a reseller prevention module 121, a trainer 125, a storage service 126, a log collector 127, and a customer manager 128. The reseller prevention module 121 may be configured to detect resellers and/or reseller activity on the retail website. The storage service may include an interface for storing data in the memory 130 and/or another location. The storage service 126 may be configured to manage a cache 302 and a database 304 (shown in FIG. 3). The cache 302 or database 304 may be stored in the memory 130 and/or at another storage collector. The trainer 125 may be configured to train a neural network 123 that is part of the reseller prevention module 121. The memory 130 may store a training data set 132, which is used by the trainer 125 to train the neural network 123. The training data set 132 is discussed in further detail with respect to FIGS. 7-8.

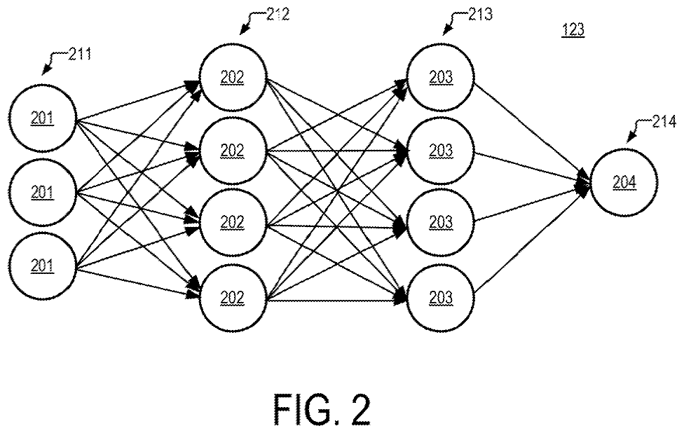

The reseller prevention module 121 may include a reseller detector 122, a streaming processor 124, a data manager 312 (shown in FIG. 3), a fraud manager 314 (shown in FIG. 3), and an event manager 316 (shown in FIG. 3). The reseller detector 122 may implement a neural network 123. The neural network 123 is discussed further below with respect to FIG. 2. The operation of the reseller prevention module 121 is discussed in further detail with respect to FIG. 3.

According to the present example, each of the reseller prevention module 121, the trainer 125, the storage service 126, the log collector 127, and the customer manager 128 is implemented in software. However, alternative implementations are possible in which any of the reseller prevention module 121, the trainer 125, the storage service 126, the log collector 127, and the customer manager 128 is implemented in hardware or as a combination of software or hardware. Although the reseller detection system 105 is depicted as an integrated system, it will be understood that alternative implementations are possible in which the reseller detection system 105 is a distributed system including a plurality of computing devices that are connected via a communications network.

FIG. 2 is a diagram of the neural network 123, according to one implementation. The neural network 123 may receive as input an activity signature of a user of the retail website. The neural network 123 may classify the activity signature into one of “reseller” and “non-reseller” categories. In other words, the neural network 123 may produce an output that is indicative of whether the user associated with the activity signature is a reseller or not.

As illustrated, the neural network 123 may include an input layer 211, a hidden layer 212, a hidden layer 213, and an output layer 214. The input layer 211, according to the example of FIG. 2, includes three input neurons 201. However, it will be understood that alternative implementations are possible in which the input layer 211 includes any number of input neurons 201. The hidden layer 212, according to the example of FIG. 2, includes four hidden neurons 202. However, it will be understood that alternative implementations are possible in which the hidden layer 212 includes any number of hidden neurons 202. The hidden layer 213, according to the example of FIG. 2, includes four hidden neurons 203. However, it will be understood that alternative implementations are possible in which the hidden layer 213 includes any number of hidden neurons 203. The output layer 214, according to the example of FIG. 2, includes one output neuron 204. However, it will be understood that alternative implementations are possible in which the output layer 214 includes any number of output neurons 204.

In some implementations, the neural network 123 may be a multilayer perceptron (MLP) network, which is a type of a feedforward neural network. Except for the input nodes in the neural network 123, each node in the neural network 123 may use a nonlinear activation function. In some implementations, the trainer 125 may use backpropagation to train the neural network 123. In some implementations, the trainer 125 may use training data, such as the training data shown in FIG. 8, to train the neural network 123.

FIG. 3 is a diagram illustrating the operation of the reseller prevention module 121, according to one implementation.

The streaming processor 124 may be configured to receive an event data stream 331. The event data stream 331 may contain data sets that are associated with different events. The events may include one or more of navigation events that are (at least in part) retrieved from web browser cookies by the hosting system 104, a credit card salted hash (CSH) events that are generated by the hosting system 104, and purchase events that are generated by the hosting system 104. As used throughout the disclosure, the phrases “event” and “data set associated with an event” may be used interchangeably.

The data manager 312 may be configured to receive events from the streaming processor 124 and store the received events in a cache 302 or a database 304 that are provided by the storage service 126. As is discussed further below, the events may be received via a publish/subscribe system. The data manager 312 may further service data read and data write requests that are received from the reseller detector 122 and the fraud manager 314. For example, the data manager 312 may retrieve data from the cache 302 and 304 and provide the retrieved data to the reseller detector 122 or the fraud manager 314. Similarly, the data manager may write to the cache 302 and/or the database 304 data that is received from the fraud manager 314 or the reseller detector 122. The event manager 316 may be configured to generate events that announce, to the fraud manager 314, the successful storage of data (in the cache 302 or database 304) by the data manager 312.

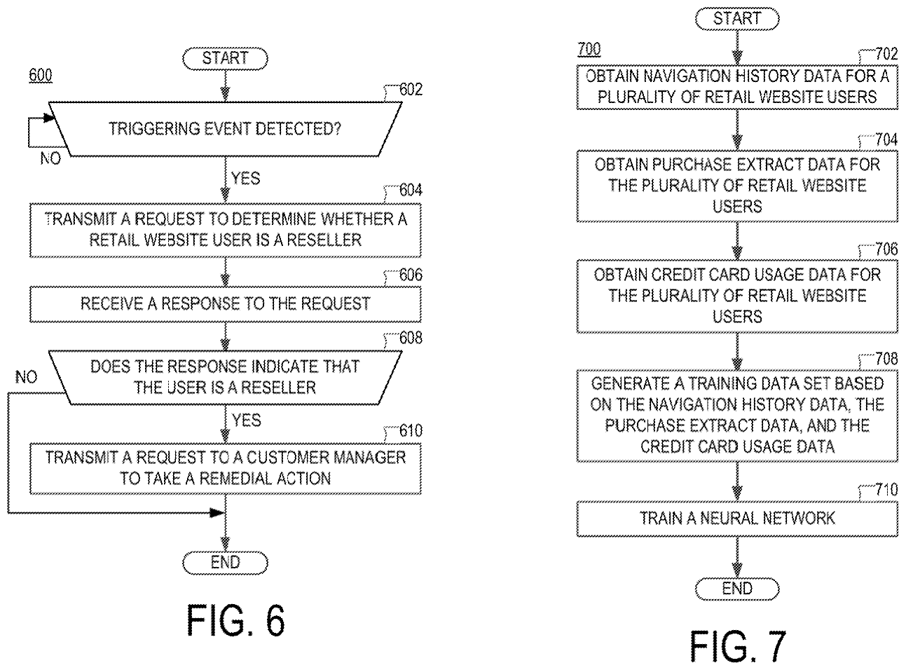

The reseller detector 122 may be configured to detect resellers and/or reseller activity on the retail website. The reseller detector 122 may be configured to execute processes 400 and 500, which are discussed further below with respect to FIGS. 5 and 6. The reseller detector 122 may receive, from the fraud manager 314, a request to determine whether a user is a reseller, classify the user as either a reseller or non-reseller, and return, to the fraud manager 314, a response indicating the outcome of the classification.

The fraud manager 314 may be configured to interact with (and/or orchestrate) the reseller detector 122 and the data manager 312. The fraud manager 314 may be configured to use the data manager 312 to retrieve and store data in the cache 302 and/or database 304. The fraud manager 314 may monitor events that are received at the reseller prevention module 121 and it may trigger reseller checks by the reseller detector 122. For example, if the fraud manager 314 notices that a user of the retail website is purchasing a large quantity of a particular product, the fraud manager 314 may cause the reseller detector 122 to determine whether the user is a reseller. As another, if the fraud manager 314 notices that a user has used a large number of credit cards to make purchases from the retail website, the fraud manager 314 may cause the reseller detector 122 to determine whether the user is a reseller. As yet another, if the fraud manager 314 notices that a user uses a large number of shipping addresses to receive purchases from the retail website, the fraud manager 314 may cause the reseller detector 122 to determine whether the user is a reseller. Upon receiving a notification from the reseller detector 122 that a particular user of the retail website is a reseller, the fraud manager may cause the customer manager 128 to take a remedial action.

The customer manager 128 may be configured to receive, from the fraud manager 314, a notification that a particular user of the retail website has been classified as a reseller. In response to the notification, the customer manager 128 may take a remedial action. The remedial action may include blocking the user. Blocking the user may include any suitable action that would prevent the user from making purchases from the retail website. For example, blocking the user may include one or more of: (i) deleting a profile of the user from a database of user profiles for the retail website that is maintained by the hosting system 104, (ii) updating a database that is maintained by the hosting system 104 to indicate that the user is no longer allowed to make purchases from the retail website, (iii) blocking the IP address of the user (either temporarily or permanently), (iv) redirecting the user to a particular page in which the user will have to answer a survey to prove that they are not a reseller, (v) making the user answer a captcha question, etc. As another example, the remedial action may include flagging the user as a reseller, without taking any specific steps to stop the user from making further purchases from the website. For example, the customer manager 128 may update a database that is maintained by the hosting system 104 to indicate that the user is a reseller.

The log collector 127 (shown in FIG. 1) may be configured to collect and store log data that is provided by different components of the reseller prevention module 121. In some implementations, one or more of the data manager 312, the streaming processor 124, the reseller detector 122, the fraud manager 314, and the event manager 316 may be configured to record log data by using the log collector 127.

The reseller detection system 105 may be integrated with the retail website that is hosted on the hosting system 104 through event middleware. When customers browse the retail website and navigate through the purchase process, their web browser can send two types of HTTP (Hypertext Transfer Protocol) requests to the e-commerce web server: (i) GET, when the web browser requests data from the server; and (ii) POST, when the web browser sends data to the server. The hosting system 104 may log each GET and POST request jointly with information regarding the customer and the page requested. The hosting system 104 may provide each event (that is submitted by using a GET or POST request(s) to the reseller detection system 105 (and/or reseller detector 122) via a publish/subscribed system which is used to consume the events that are generated in the hosting system 104 as soon a they are generated.

In some implementations, each of the storage service 126, the data manager 312, the streaming processor 124, the reseller detector 122, the fraud manager 314, the event manager 316, and the customer manager 128 may be implemented as a microservice. In some implementations, the fraud manager 314 may act as an orchestrator for the microservices.

Examples of different types of data items, which may be part of a navigation event, are provided with respect to Table 1 below. In some implementations, a navigation event may include only one or fewer than all of the data items that are listed in Table 1. Each row in Table 1 identifies a different data item that is part of a navigation event and explains the information that is represented by the data item. In some implementations, navigation events for a given user of the retail website may identify what (product) pages of the retail website are visited by the given user, in what order, as well as various other characteristics of the visits. In some respects, Table 1 includes customer browser interaction data that is collected using a JavaScript library called “Boomerang”. Some of the table contents are collected from Browser cookies, but others are collected from request/response headers and URL properties of pages that are visited by the customer. As another example, IsBot may be a calculated field based on user interaction information that is obtained in this manner.

TABLE 1
Examples of data items that can be part of a navigation event.

| Field | Description |
|---|---|
| _TIME | Event capture time by the retail website. |
| MCMID | User unique identification based on the web browser cookies. |
| BROWSER_VERSION | User web browser version. |
| COUNTRY | The country of the retail website web page the user is browsing. |
| CUSTOMERSET | Customer classification. |
| SEGMENT | The retail website sector referring to the page the user is identified |
| | by this data item. |
| DGV | Information about how the user entered the site |
| ISBOT | Classification defining the user as “bot” or “non-bot”. |
| PAGETYPE | Category referring to the URL of the retail website where the user |
| | is browsing |
| URL | URL the user requested. |
| REFERRER | The previous URL the user visited |

Examples of different types of data items, which may be part of a CSH event, are provided with respect to Table 2 below. In some implementations, a CSH event may include only one or fewer than all of the data items that are listed in Table 2. Each row in Table 2 identifies a different data item that can be part of a CSH event and explains the information that is represented by the data item. In some implementations, a CSH event may identify a credit card that is used by any user of the retail website to make purchases from the retail website, as well as other information relating to credit card usage.

TABLE 2
Examples of data items that can be part of a CSH event.

| Field | Description |
|---|---|
| _TIME | Event capture time by the retail website. |
| MCMID | User unique identification based on the web browser cookies. |
| IPADDRESS | User's IP address. |
| IP_COUNTRY | IP address country. |
| IP_CITY | IP address city. |
| SESSIONID | A unique identifier representing the customer session. |
| PROFILEID | A unique identifier representing the customer profile. |
| LOGGEDIN | A Flag that represents whether the user is logged in or not. |
| X_FORWARDED_FOR | The number of network hops from the customer client to the |
| | server. |
| USER_AGENT | Information about the device and browser of the user. |
| CSH | Hash information of a credit card information that is used for |
| | payment. |
| COUNTRY | The country of the retail website web page web page the user is |
| | browsing. |
| URL | URL the user requested. |

Examples of different types of data items, which may be part of a purchase event, are provided with respect to Table 3 below. In some implementations, a purchase event may include only one or fewer than all of the data items that are listed in Table 3. Each row in Table 3 identifies a different data item that can be part of a purchase event and explains the information that is represented by the data item. In some implementations, a purchase event may identify a product that is purchased by the user, a time when the purchase is made, shipping address information for the purchase, as well as other information regarding the circumstances of the purchase.

TABLE 3
Examples of data items that can be part of a purchase event.

| Field | Description |
|---|---|
| _TIME | Event capture time by the retail website. |
| MCMID | User unique identification based on the web browser |
| | cookies. |
| IPADDRESS | User's IP address. |
| IP_COUNTRY | IP address country. |
| SESSIONID | A unique identifier representing the user's session. |
| FORMFACTOR | Type of device of the user |
| BROWSER | Browser name |
| DEVICE | User device model |
| OS | User's operating system. |
| LOGGEDIN | A Flag that represents whether the user is logged in or not. |
| PROFILEID | A unique identifier representing the customer profile. |
| DPID | Order unique identifier |
| COUNTRY | The country of the retail website web page the user is |
| | browsing. |
| SEGMENT | The sector referring to the page the user is. |
| PRODUCTID | Identifier of the product. |
| ITEMQUANTITY | Quantity of products in the order. |
| PRODUCTTYPE | Product classification according to the e-commerce |
| PAYMENTTYPENAME | Form of payment |
| BILLING_EMAIL | Billing e-mail information. |
| SHIPPING_EMAIL | Shipping e-mail information. |
| BILLING_POSTALCODE | Billing postal code information. |
| SHIPPING_POSTALCODE | Shipping postal code information. |
| BILLING_STREET | Billing street information. |
| SHIPPING_STREET | Shipping street information. |
| BILLING_COUNTRY | Billing country information. |
| SHIPPING_COUNTRY | Shipping country information. |
| BILLING_CITY | Billing city information. |
| SHIPPING_CITY | Shipping city information. |
| POSTALCODE | Postal code of the profile of the user |
| EMAIL | User's e-mail. |
| PAYMENTTYPECODE | Code of the form of payment |
| CSH | Hash identification of the credit card informed for payment. |

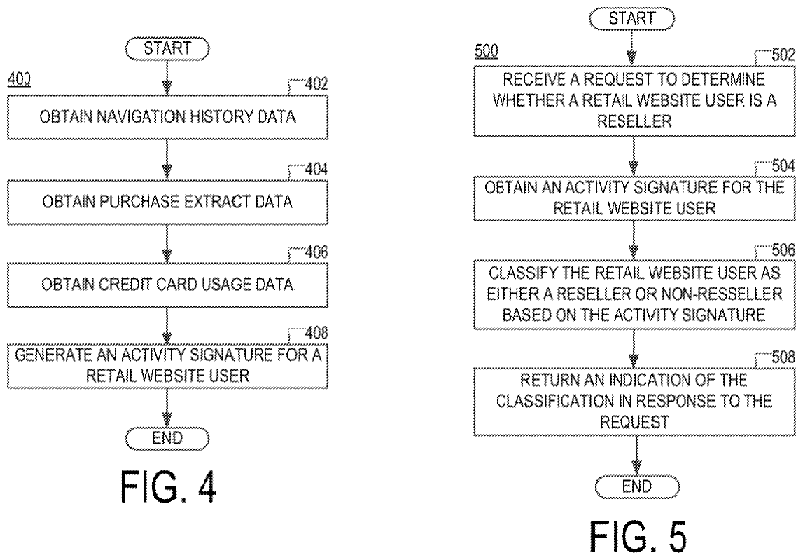

FIG. 4 is a flowchart of an example of a process 400 for generating an activity signature for a retail website user (hereinafter “the user”). According to the example of FIG. 4, the process 400 is performed by the reseller detector 122. However, alternative implementations are possible in which the process 400 is performed by another component of the reseller prevention module 121 or the hosting system 104. It will be understood that the present disclosure is not limited to any specific entity executing the process 400.

At step 402, the reseller detector 122 obtains navigation history data. The navigation history data may include one or more navigation events that are associated with the user. The navigation history data may also include one or more navigation events that are associated with other users of the retail website. The one or more navigation events may be retrieved from the cache 302 and/or database 304 by using the data manager 312, and they may be received at the reseller detection system 105 via the streaming processor 124.

At step 404, the reseller detector 122 obtains purchase extract data. The purchase extract data may include one or more purchase events that are associated with the user. The purchase extract data may also include one or more purchase events that are associated with other users for the retail website (e.g., other users that have used the same IP address or device as the user to access the retail website). The one or more purchase events may be retrieved from the cache 302 and/or database 304 by using the data manager 312, and they may be received at the reseller detection system 105 via the streaming processor 124.

At step 406, the reseller detector 122 obtains credit card usage data. The credit card usage data may include one or more CHS events that are associated with the user. The credit card usage data may also include one or more CHS events that are associated with other users who have used the same credit card as the user to pay for purchases made in the past. The one or more CHS events may be retrieved from the cache 302 and/or database 304 by using the data manager 312, and they may be received at the reseller detection system 105 via the streaming processor 124.

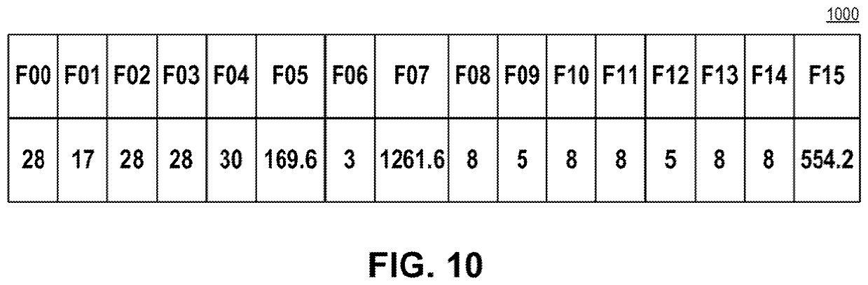

At step 408, the reseller detector 122 generates an activity signature for the retail website user. Generating an activity signature may include instantiating the activity signature, generating one or more features based on the data received at steps 402-406, and including the generated features into the instantiated activity signature. In some implementations, the generated activity signatures may be the same or similar to the activity signature 1000, which is shown in FIG. 10. As illustrated, the activity signature may be a vector, wherein each element in the vector is a different feature. In the example of FIG. 10, the activity signature includes features F00-F15, which are discussed further below with respect to Table 4. Although in the example of FIG. 10 the activity signature 1000 includes 16 features, it will be understood that the present disclosure is not limited to any number of type of features being included in the activity signature 1000.

Examples of different types of features that may be part of the user activity signature (and which may be generated at step 408) are provided with respect to Table 4 below.

| ID | Description | Source |
|---|---|---|
| 00 | How many times that CSH was used | CSH |
| 01 | How many CSH that IP used | CSH |
| 02 | How many CSH that MCMID used | CSH |
| 03 | How many CSH that Profile ID used | CSH |
| 04 | How many CSH that the user tried | CSH |
| 05 | Mean time between CSH usage of the user | CSH |
| 06 | Number of pages that the user requested | NAV |
| 07 | Mean time between page requests | NAV |
| 08 | How many orders have been placed for that product by that user | PUR |
| 09 | How many orders have been placed for that product of that IP | PUR |
| | Address | |
| 10 | How many purchases have been placed by that MCMID | PUR |
| 11 | How many purchases have been placed by that Profile Id | PUR |
| 12 | How many purchases have been placed by that IP Address | PUR |
| 13 | How many purchases have been placed by that User | PUR |
| 14 | How many purchases have been placed with that CSH | PUR |
| 15 | Mean time between user purchases | PUR |

Feature ‘00’ may identify how many times a given credit card was used to make purchases from a retail website. Feature ‘00’ may identify the number of times the credit card was used by the user, as well as other users of the retail website. This feature may be used to detect resellers that access the website under different user identities, while using the same payment information. Feature ‘00’ may be generated based on credit card usage data that is received at step 406. In instances in which the generation of the activity signature is triggered in response to the user attempting to complete a purchase, the given credit card number may be one that the user is attempting to use for the purchase.

Feature ‘01’ may indicate how many different credit card numbers have been used by the same IP address (i.e., the IP address of the user) to complete purchases from the retail website. Feature ‘01’ may be used to detect whether a reseller is trying to avoid detection (by the hosting system 104) by using several different credit cards to purchase products from the website. Feature ‘01’ may be generated based on credit card usage data that is received at step 406.

Feature ‘02’ may indicate how many different credit card numbers are used by the same MCMID (i.e., the MCMID of the user) to complete purchases from the retail website. As indicated in Tables 1-3, an MCMID may be a unique identification of a user that is stored in browser cookies on device(s) that are used by the user to make purchases from the retail website. Feature ‘02’ may be generated based on credit card usage data that is received at step 406.

Feature ‘03’ may indicate how many different credit card numbers have been used by the same MCMID (i.e., an MCMID that is associated with the user). As indicated in Tables 1-3, an MCMID may be a unique identification of a user that is stored in browser cookies on device(s) that are used by the user to make purchases from the retail website. Feature ‘03’ may be generated based on credit card usage data that is received at step 406.

Feature ‘04’ may indicate how many different credit card numbers the user has attempted to use to make purchases from the retail website (irrespective of whether the user was successful in completing the purchases from the retail website). Feature ‘04’ may be generated based on credit card usage data that is received at step 406.

Feature ‘05’ may indicate the mean time between consecutive credit card transactions that are completed (and/or attempted) by the user. In some implementations, feature ‘05’ may identify the meantime between transactions associated with the same credit card number. Alternatively, in some implementations, feature ‘05’ may identify the meantime between credit card transactions that are associated with different credit cards. Feature ‘05’ may be generated based on credit card usage data that is received at step 406.

Feature ‘06’ may indicate how many different product pages of the retail website the user has visited. A product page may be a web-page that includes information about a product that is sold on the retail website, and it may also include a user interface component (e.g., a buy button, etc.) that enables the user to add the product to the user's shopping cart and/or purchase the product. Feature ‘06’ may be calculated based on navigation data that is received at step 402.

Feature ‘07’ may indicate the mean time between product page requests that are made by the user. Feature ‘07’ may be calculated based on navigation data that is received at step 402.

Feature ‘08’ may indicate the number of purchases of a given product that have been made by the user during a predetermined time period. The given product may be one that the user has attempted to purchase, in an attempt that has prompted the fraud manager 314 to determine whether the user is a reseller and trigger the generation of an activity signature for the user. Feature ‘08’ may be calculated based on purchase data that is received at step 404.

Feature ‘09’ may indicate the number of purchases a given product that have been made by the same IP address. The given product may be one that the user has attempted to purchase, in an attempt that has prompted the fraud manager 314 to determine whether the user is a reseller and trigger the generation of an activity signature for the user. Feature ‘09’ may be calculated based on purchase data that is received at step 404.

Feature ‘10’ may indicate the number of purchases from the retail website that have been completed by the same MCMID (e.g., an MCMID that is stored on a device used by the user). Feature ‘10’ may be calculated based on purchase data that is received at step 404.

Feature ‘11’ may indicate the number of purchases from the retail website that have been made by the same profile ID (e.g., a profile ID that is used by the user). Feature ‘11’ may be calculated based on purchase data that is received at step 404. In general users may be tracked by the hosting system 104 based on a browser cookie called MCMID which will track not only the current session but also track customer behavior for 2 years or until cookies are deleted from the client machine or when a new browser is used (Chrome vs IE vs Firefox). However, if a user is logged into a website (using a registered account), the user may also be associated with a profile ID. In general, the examples of determining whether the “same user” is associated with different devices, different IP addresses, or different credit card information refer to detecting whether the same MCMID is related to different IP addresses, different credit card information, or different devices.

Feature ‘12’ may indicate how many purchases have been made by the same IP address (e.g., an MCMID that is associated the user). Feature ‘12’ may be calculated based on purchase data that is received at step 404.

Feature ‘13’ may indicate how many purchases have been made by the user. Feature ‘13’ may be calculated based on purchase data that is received at step 404.

Feature ‘14’ may identify how many times a given credit card was used by the user to make purchases from a retail website. The given card may be a card that the user has attempted to use in a purchase attempt, which has prompted the fraud manager 314 to determine whether the user is a reseller and trigger the generation of the activity signature for the user. Feature ‘14’ may be generated based on purchase data that is received at step 404.

Feature ‘15’ may identify the mean time between purchases from the retail website that are made by the user. Feature ‘15’ may be generated based on purchase data that is received at step 404. It will be understood that features ‘00’-‘15’ are provided as an example only, and the present disclosure is not limited to using those features only. Those of ordinary skill in the art will readily recognize, after reading this disclosure, that various features may be generated based on the information obtained at steps 402-406.

FIG. 5 is a flowchart of an example of process 500, according to aspects of the disclosure. According to the example of FIG. 5, the process 500 is performed by the reseller detector 122. However, alternative implementations are possible in which the process 500 is performed by another component of the reseller prevention module 121 and/or another component of the hosting system 104. It will be understood that the present disclosure is not limited to any specific entity executing the process 500. At step 502, the reseller prevention module 121 receives a request to determine whether a user of the retail website is a reseller. The request is received from the fraud manager 314. At step 504, the reseller prevention module 121 obtains an activity signature for the retail website user. In some implementations, the reseller prevention module 121 may obtain the activity signature by executing the process 400, which is discussed above with respect to FIG. 4. However, the present disclosure is not limited to any specific manner of obtaining the activity signature. At step 506, the reseller prevention module 121 classifies the activity signature (obtained at step 504) with the neural network 123 (shown in FIGS. 1B-2). Specifically, the reseller prevention module 121 evaluates the neural network 123 based on the activity signature. Evaluating the neural network 123 may yield a classification result, which indicates whether the user has been classified as a reseller. If the classification result has a first value (or a first range of values), this may indicate that the user has been classified as a reseller. On the other hand, if the classification result has a second value (or a second range of values), this may indicate that user has been classified as a non-reseller. At step 508, the reseller prevention module 121 returns, to the fraud manager 314, an indication of the outcome of the classification (i.e., an indication of whether the user has been classified as a reseller).

FIG. 6 is a flowchart of an example of a process 600, according to aspects of the disclosure. At step 602, the fraud manager 314 detects whether a triggering event is detected. According to the present example, the triggering event may be detected in response to a user attempting to make a purchase from the retail website. However, it will be understood that the present disclosure is not limited to any specific type of triggering event. If a triggering event is detected, the process 600 proceeds to step 604. Otherwise, step 602 is repeated. At step 604, the fraud manager transmits, to the reseller detector 122, a request to determine whether a retail website user is a reseller. The request may be the same or similar to the request received at step 502 of the process 500 (shown in FIG. 5). At step 606, a response to the request is received from the reseller detector 122. The response may indicate whether or not the user has been classified as a reseller by the reseller detector 122. The response may be the same or similar to the response transmitted at step 508 of the process 500 (shown in FIG. 5). At step 608, a determination is made if the response indicates that the user is a reseller. If the response indicates that the user has been classified as a reseller by the reseller detector 122, the process 600 proceeds to step 610. Otherwise, the process 600 ends. At step 610, the fraud manager 314 transmits to the customer manager 128, a request to take a remedial action. As discussed above, in response to the request, the customer manager 128 may block the user, flag the user as a reseller, redirect the user to a verification page, make the user answer a captcha question, and/or take any other suitable action.

FIG. 7 is a flowchart of an example of a process 700, according to aspects of the disclosure. At step 702, the trainer 125 obtains navigation data for a plurality of users of the retail website. The obtained navigation data may include navigation events, wherein each of the navigation events is associated with one of the plurality of users. The navigation data may be retrieved by using the storage service 126 and/or in any other suitable manner. At step 704, the trainer 125 obtains purchase extract data for the plurality of users. The obtained purchase extract data may include purchase events, wherein each of the purchase events is associated with one of the plurality of users. The purchase extract data may be retrieved by using the storage service 126 and/or in any other suitable manner. At step 706, the trainer 125 obtains credit card usage data for the plurality of retail website users. The obtained credit card usage data may include CHS events, wherein each of the CHS events is associated with one of the plurality of users. The credit card usage data may be retrieved by using the storage service 126 and/or in any other suitable manner. At step 708, the trainer 125 generates the training data set 132 based on the data obtained at steps 702-706. Generating the training data set 132 may include: (i) generating a respective activity signature for each of the plurality of users, and (ii) attaching a label to each of the activity signatures, which indicates whether the activity signature's respective user is considered to be a reseller. Each of the labels may be generated manually or in any other suitable manner. Each of the activity signatures may be generated based on the data received at steps 702-708. At step 710, the trainer 125 trains the neural network based on the training data set 132.

FIG. 8 is a diagram of an example of the training data set 132. The training data set 132 is presented as a table. Each row in the table corresponds to a different activity signature and a label that is assigned to the activity signature. The label for any of the activity signatures, according to the present example, is a binary value. When the label for a given activity signature is set to ‘0’, this is an indication that the user associated with the activity signature is not a reseller. When the label for a given activity signature is set to ‘1’, this is an indication that the user associated with the activity signature is a reseller. In some respects, FIG. 8 illustrates that each of the activity signature is a vector, wherein each of the elements in the vector is a different one of the features F00-F15 (discussed with respect to table 4). Furthermore, FIG. 8 illustrates that each of the features F00-F15 may be a numerical value (e.g., an integer or a floating-point number, etc.)

Referring to FIG. 9, computing device 900 may include processor 902, volatile memory 904 (e.g., RAM), non-volatile memory 906 (e.g., a hard disk drive, a solid-state drive such as a flash drive, a hybrid magnetic and solid-state drive, etc.), graphical user interface (GUI) 908 (e.g., a touchscreen, a display, and so forth) and input/output (I/O) device 920 (e.g., a mouse, a keyboard, etc.). Non-volatile memory 906 stores computer instructions 912, an operating system 916 and data 918 such that, for example, the computer instructions 912 are executed by the processor 902 out of volatile memory 904. Program code may be applied to data entered using an input device of GUI 908 or received from I/O device 920.

Processor 902 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard-coded into the electronic circuit or soft coded by way of instructions held in a memory device. A “processor” may perform the function, operation, or sequence of operations using digital values or using analog signals. In some embodiments, the “processor” can be embodied in an application-specific integrated circuit (ASIC). In some embodiments, the “processor” may be embodied in a microprocessor with associated program memory. In some embodiments, the “processor” may be embodied in a discrete electronic circuit. The “processor” may be analog, digital or mixed-signal. In some embodiments, the “processor” may be one or more physical processors or one or more “virtual” (e.g., remotely located or “cloud”) processors.

FIGS. 1A-10 provide examples of processes and systems that can be used to facilitate the generation of as-service offerings by an organization. The processes and systems can be used to evaluate the throughput of a system that is being offered under a guarantee that the system is capable of achieving specific throughput. The processes and system receive as input a hardware configuration for the system, and output an indication of whether the hardware configuration is capable of delivering the guaranteed throughput that is being.

In one aspect, the processes and systems take advantage of telemetry data to train a neural network (or another machine learning model) to classify hardware configurations according to expected throughput. Such telemetry data may be routinely reported by hardware as a matter of course or during interactions with customer support personnel.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid-state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method, comprising:
obtaining an activity signature for a first user of a retail website, the activity signature being based on one or more of navigation data for the first user of the retail website, purchase data for the first user of the retail website, and credit card usage data for the first user of the retail website;
detecting whether the first user of the retail website is a reseller by classifying the activity signature for the first user with a neural network; and
updating a configuration of a hosting system of the retail website when the first user of the retail website is detected to be a reseller.

2. The method of claim 1, wherein a reseller is any user of the retail website who purchases one or more products from the retail website with an intent of reselling the one or more products.

3. The method of claim 1, wherein updating the configuration of the hosting system includes one of: (i) storing in a memory of the hosting system an indication that the first user of the retail website is detected to be a reseller and/or (ii) blocking the first user of the retail website from using the retail website.

4. The method of claim 1, wherein obtaining the activity signature includes:
receiving the navigation data for the first user of the retail website;
receiving the purchase data for the first user of the retail website;
receiving the credit card usage data for the first user of the retail website; and
generating the activity signature for the first user of the retail website based on the navigation data for the first user of the retail website, the purchase data for the first user of the retail website, and the credit card usage data for the first user of the retail website.

5. The method of claim 1, wherein the activity signature is generated based on credit card usage data for a second user of the retail website who has used or is attempting to use a same credit card as the first user.

6. The method of claim 1, wherein the activity signature for the first user includes a feature that is indicative of a mean time between credit card purchases that are made by the user, the credit card purchases including one or more purchases that are made with a first credit card, and one or more purchases that are made with a second credit card.

7. The method of claim 1, wherein the activity signature for the first user includes feature that is indicative of a count of Internet Protocol (IP) addresses that are associated with a credit card that is used by the first user of the retail website.

8. A system, comprising:
a memory; and
one or more processors operatively coupled to the memory, the one or more processors being configured to perform the operations of:
obtaining an activity signature for a first user of a retail website, the activity signature being based on one or more of navigation data for the first user of the retail website, purchase data for the first user of the retail website, and credit card usage data for the first user of the retail website;
detecting whether the first user of the retail website is a reseller by classifying the activity signature for the first user with a neural network; and
updating a configuration of a hosting system of the retail website when the first user of the retail website is detected to be a reseller.

9. The system of claim 8, wherein a reseller is any user of the retail website who purchases one or more products from the retail website with an intent of reselling the one or more products.

10. The system of claim 8, wherein updating the configuration of the hosting system includes one of: (i) storing in a memory of the hosting system an indication that the first user of the retail website is detected to be a reseller and/or (ii) blocking the first user of the retail website from using the retail website.

11. The system of claim 8, wherein obtaining the activity signature includes:
receiving the navigation data for the first user of the retail website;
receiving the purchase data for the first user of the retail website;
receiving the credit card usage data for the first user of the retail website; and
generating the activity signature for the first user of the retail website based on the navigation data for the first user of the retail website, the purchase data for the first user of the retail website, and the credit card usage data for the first user of the retail website.

12. The system of claim 8, wherein the activity signature is generated based on credit card usage data for a second user of the retail website who has used or is attempting to use a same credit card as the first user.

13. The system of claim 8, wherein the activity signature for the first user includes a feature that is indicative of a mean time between credit card purchases that are made by the user, the credit card purchases including one or more purchases that are made with a first credit card, and one or more purchases that are made with a second credit card.

14. The system of claim 8, wherein the activity signature for the first user includes feature that is indicative of a count of Internet Protocol (IP) addresses that are associated with a credit card that is used by the first user of the retail website.

15. A non-transitory computer-readable medium storing one or more processor-executable instructions, which, when executed by at least one processor, cause the at least one processor to perform the operations of:
obtaining an activity signature for a first user of a retail website, the activity signature being based on one or more of navigation data for the first user of the retail website, purchase data for the first user of the retail website, and credit card usage data for the first user of the retail website;
detecting whether the first user of the retail website is a reseller by classifying the activity signature for the first user with a neural network; and
updating a configuration of a hosting system of the retail website when the first user of the retail website is detected to be a reseller.

16. The non-transitory computer-readable medium of claim 15, wherein a reseller is any user of the retail website who purchases one or more products from the retail website with an intent of reselling the one or more products.

17. The non-transitory computer-readable medium of claim 15, wherein updating the configuration of the hosting system includes one of: (i) storing in a memory of the hosting system an indication that the first user of the retail website is detected to be a reseller and/or (ii) blocking the first user of the retail website from using the retail website.

18. The non-transitory computer-readable medium of claim 15, wherein obtaining the activity signature includes:
receiving the navigation data for the first user of the retail website;
receiving the purchase data for the first user of the retail website;
receiving the credit card usage data for the first user of the retail website; and
generating the activity signature for the first user of the retail website based on the navigation data for the first user of the retail website, the purchase data for the first user of the retail website, and the credit card usage data for the first user of the retail website.

19. The non-transitory computer-readable medium of claim 15, wherein the activity signature is generated based on credit card usage data for a second user of the retail website who has used or is attempting to use a same credit card as the first user.

20. The non-transitory computer-readable medium of claim 15, wherein the activity signature for the first user includes a feature that is indicative of a mean time between credit card purchases that are made by the user, the credit card purchases including one or more purchases that are made with a first credit card, and one or more purchases that are made with a second credit card.
